(19) United States
(12) Patent Application Publication
(10) Pub. No.: US 2017/0045936 A1
(43) Pub. Date: Feb. 16, 2017

(54) Adjusting Display Brightness Based on User Distance

(71) Applicant: HEWLETT-PACKARD DEVELOPMENT COMPANY, L.P., HOUSTON, TX (US)

(72) Inventor: VISHAL KAKAPURI, BANGALORE (IN)

(73) Assignee: Hewlett-Packard Development Company, L.P., Houston, TX (US)

(21) Appl. No.: 15/118,589

(22) PCT Filed: Apr. 7, 2014
(86) PCT No.: PCT/US2014/033183

§ 371 Date: Aug. 12, 2016

(51) Int. Cl. G06F 3/01; G09G 5/10

(52) U.S. Cl. CPC G06F 3/013; G09G 5/10; G09G 2320/0626; G09G 2320/0606; G09G 2320/08; G09G 2354/00; G09G 2360/144

(57) ABSTRACT

A computing device in accordance with an example includes a display surface. The device also includes a first sensor to determine a distance of a user from the device, a second sensor to determine an ambient brightness of the device, and a controller to automatically adjust a brightness of the display surface based on the distance of the user from the device and the ambient brightness.

### BACKGROUND

A computing device may include a display device to interface with a user. For example, the display device may present information and content to the user, and also accept input from the user (e.g., computing devices with touchscreen feature). Due to the increasing capabilities of portable computing devices like tablets and smartphones, users spend more time on their devices and interacting with their devices via the display.

### BRIEF DESCRIPTION OF THE DRAWINGS

Some examples of the present application are described with respect to the following figures:

FIG. 1 illustrates an example of a computing device including a controller to adjust a brightness of a display surface based on a distance of a user from the device;

FIG. 2 illustrates an example of a computing device that adjusts a brightness of a display surface based on a distance of a user from the device;

FIG. 3 is an example of a flowchart illustrating a method for adjusting a brightness of a display screen of a computing device based on a distance of a user from the device;

FIG. 4 is another example of a flowchart illustrating a method for adjusting a brightness of a display screen of a computing device based on a distance of a user from the device; and

FIG. 5 illustrates an example of a computing device including a computer-readable medium having instructions to adjust a brightness of a display screen based on a distance of a user from the device.

### DETAILED DESCRIPTION

With the rapid development of mobile devices and applications that run on the mobile devices users are spending more time reading content from the mobile devices. For example, a mobile device may function as an e-reader (or enabled with an e-reader) for reading digital or electronic books (i.e., e-books), newspaper, journals, and periodicals. Because users are spending more time consuming content from their mobile devices, there may be a strain on their eyes due to the close proximity of the user to the display and the brightness of the display.

To optimize power consumption, some devices have an auto mode/feature where the display may turn off or dim after a period of inactivity or when no user interaction occurs. However, this feature may not consider that, although the user is not interacting with the device (e.g., providing input via virtual keyboard or touchscreen), the user may be reading content on the display and turning off or dimming the display in such a situation may be annoying or frustrating to a user. Further, where the auto mode/feature is disabled, the display may be set at a fixed or particular brightness level and when the ambient brightness of the device changes (e.g., brightness of an external environment of the device), the brightness of the display may not change relative to the ambient brightness.

The described examples address the above challenges by providing a solution for automatically adjusting the brightness of a display based on a combination of the distance of the user from the device and the ambient brightness of the device. For example, the brightness of the display changes based on the proximity of the user to the device, and the magnitude or the rate of the change in brightness is function of the ambient brightness of the device. To illustrate, in a well lit room, the change in brightness of the device to the proximity of the user to the device may be X/cm, however in a dimly lit room the change in brightness of the device to the proximity of the user may be Y/cm, where X<Y. By automatically adjusting the brightness of the device based on the proximity of the user to the device and the brightness of the environment, the strain on the user's eyes can be alleviated and power consumption can be optimized, thereby improving overall user experience.

In one example, a computing device includes a display surface. The device also includes a first sensor to determine a distance of a user from the device, a second sensor to determine an ambient brightness of the device, and a controller to automatically adjust a brightness of the display surface based on the distance of the user from the device and the ambient brightness.

In another example, a method for adjusting a brightness of a display screen of a computing device includes determining, by a first sensor, a distance of a user from the device and determining, by a second sensor, an ambient brightness of the device. The method also includes automatically adjusting the brightness of the display screen based on the distance of the user from the device and the ambient brightness.

In another example, a non-transitory computer-readable storage medium includes instructions that, when executed by a controller of a computing device, cause the computing device to determine a distance of a user from the device and determine an ambient brightness of the device. The instructions are executable to automatically adjust the brightness of a display screen of the device based on the distance of the user from the device and the ambient brightness of the device.

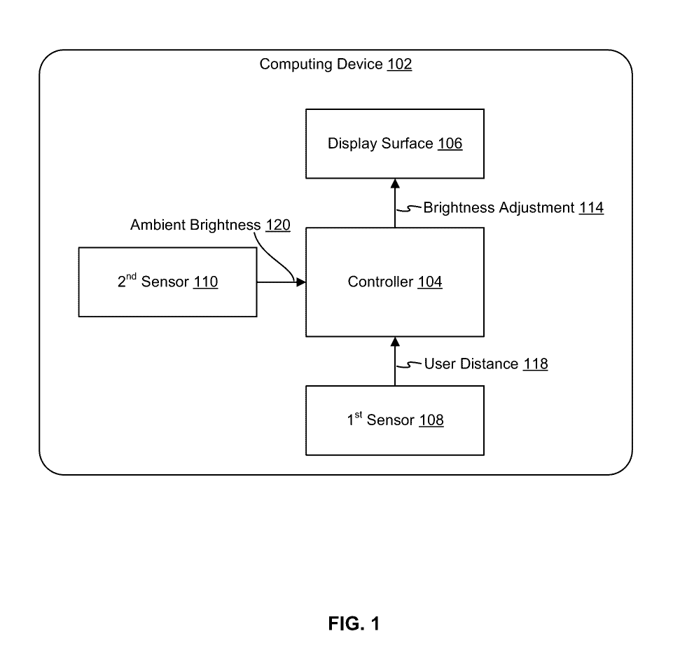

Referring now to the figures, FIG. 1 is an example of a computing device including a controller to adjust a brightness of a display surface based on a distance of a user from the device. Computing device 102 can be a tablet computing device, a smartphone, a hybrid portable computing device, a personal digital assistant (PDA), a mobile device, a media player, a portable reading device, or any other personal computing device that includes a display surface 106, for example. Computing device 102 can also include a controller 104, a first sensor 108 and a second sensor 108.

Display surface 106 can be a light-emitting diode (LED), a plasma display, a liquid crystal display (LCD), an organic light-emitting diode display (OLED), a cathode-ray tube (CRT) display, or any display technology, for example. The display surface 106 can be a 2-dimensional or a 3-dimensional display. Further, display surface 106 can be a touch-sensitive, touchscreen, or any interactive display such as a capacitive touchscreen where a user's finger may function as a mouse and cursor to provide input and/or where a stylus pen may be used to provide input. Alternatively, or in addition, display surface 106 may provide or display an onscreen virtual keyboard for interacting with the computing device 102. In such an example, a virtual keyboard image my be displayed on the display surface and alphanumeric input may be provided using the virtual keyboard.

First sensor 108 can be any sensor for determining a distance 118 of a user from the device 102. For example, sensor 108 can include at least one of an image sensor and a sound sensor. As an image sensor, sensor 108 can be a camera, an image capture device, or any other device that can detect the presence of a user in close proximity to the device 102 and determine the distance 118 of the user from the device 102. As an example, sensor 108 can intermittently emit light (at a predetermined time period) and receive the light emitted that is reflected from the user to determine the distance 118 of the user from the device 102 (or from the display surface 106). As another example, sensor 108 can be an image sensor e.g., a 3D image sensor) that measures distance 118 using time-of-flight techniques based on the time it takes light to travel to an object (e.g., the user) and back to the sensor (i.e., receiver).

As a sound sensor, sensor 108 can be a sensor that measures sound intensity to estimate or determine the distance 118 of the user. For example, the sensor 108 can measure an intensity of a user's voice or surrounding sound to determine the distance 118 of the user to the device 102 (e.g., while the user is talking on a phone, video conferencing, or idle). Further, sensor 108 can be an ultrasonic sensor that periodically generates high frequency sound waves and evaluates the echo which is received back by the sensor, and the sensor calculates the time interval between sending the signal and receiving the echo to determine the distance 118 of an object (e.g., the user) to the device 102. Accordingly, sensor 108 can use light and/or sound to determine the distance 118 of the user from the device 102.

Second sensor 110 can be any sensor to determine an ambient brightness 120 of the device 102. For example, sensor 110 can be a light sensing device that measures the intensity of the light in an environment of the device 102, such as a photosensor, photodetector, or an ambient light sensor. Thus sensor 110 can measure the level of ambient light for the device 102.

Controller 104 can be a combination of hardware and software to manage certain functionality of the device 102. For example, controller 104 can automatically adjust the brightness of the display surface 106 based on the distance 118 of the user from the device and the ambient brightness 120 of the device 102. Controller 104 can be an embedded controller or a display controller, for example.

Controller 104 may receive an output of the user's distance 118 from the first sensor 108 and an output of the ambient brightness 120 from the second sensor 110, and automatically adjust the brightness level of the display surface 106. For example, controller 104 can send a brightness adjustment signal 114 to the display surface 106 to control the brightness of the display surface 106. Controller 104 can increase the brightness of the display surface 106 as the user's distance from the device 102 increases, and decrease the brightness of the display surface 106 as the user's distance from the device 102 decreases. Further, the magnitude or rate of change of the brightness of the display surface 106 with distance is a function of the ambient brightness.

To illustrate, if the brightness of the display surface is measured in voltage (V), and the distance of the user to the device 102 is measured in centimeters (cm), controller 104 can apply a 0.1V/cm change to the brightness of the display surface 106 when the environment (e.g., a room) is well lit, and apply a 0.2V/cm chance to the brightness of the display surface 106 when the environment is dimly lit. Accordingly, the magnitude of the change in brightness with distance can be based on (or a function) of the ambient brightness.

In some examples, the user can be provided with an option to enable or disable the automatic adjustment of the brightness. In such an example, the user may be provided with a graphical user interface (GUI) for selecting or deselecting the auto brightness adjustment feature. In certain examples, the brightness of the display surface 106 can be controlled based upon a user input or a pre-configured value input by the user, such as increasing or decreasing the brightness of the display surface 106 by a certain percentage (e.g., 5% of current brightness factor). In such an example, the user may provide a different value for the increase factor than the decrease factor, or provide the same increase and decrease factor. In some examples, the rate of change of brightness of the display surface with distance of the user may be based on the increase/decrease factor provided by the user.

In certain examples, the controller 104 can dim the display surface 106 when the first sensor 108 does not detect the presence of the user after a first predetermined period of time (e.g., 1 minute), to conserve power consumption of the device 102. In other examples, the controller 104 can turn off the display surface 106 when the sensor 108 does not detect the presence of the user after a second predetermined period of time (e.g., 1 minutes or 2 minutes), to conserve power.

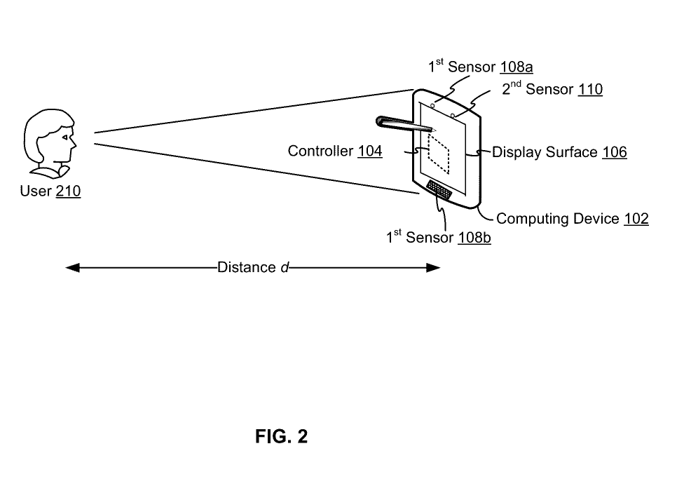

FIG. 2 is an example of a computing device that adjusts a brightness of a display surface based on a distance of a user from the device. In the example of FIG. 2, computing device 102 includes a display surface 106, first sensors 108a-108b, and second sensor 110. Controller 104 is internal to the device 102 and is thus shown in dotted lines.

First sensor 108a can be an image sensor such as an image capture device, a camera, a 3D image sensor, or any other device that can detect the presence of the user 210 and determine the distance d of the user 210 from the device 102. First sensor 108b can he a sound sensor such as an ultrasonic sensor that can detect a user's voice and/or measure the intensity of the user's voice to determine the distance d of the user 210 from the device 102. It should be noted that distance d determination of the user 210 from the device 106 can be performed by one or more first sensors 108 of the device 102. Second sensor 110 can be a light sensing device such as a photosensor, a photodetector, or an ambient light sensor to determine ambient brightness.

Controller 104 can automatically adjust the brightness of the display surface 106 based on the distance d of the user 210 to the device 102 and the ambient brightness. For example, controller 104 can change the brightness of the display surface 106 at a first rate as the distance d of the user changes, when the ambient brightness is within a first threshold, and change the brightness of the display surface 106 at a second rate as the distance d of the user changes, when the ambient brightness is within a second threshold. To illustrate, the first rate of change when the ambient brightness is within a first threshold can be X/d while the second rate of change when the ambient brightness is within a second threshold can be Y/d. Thus, at the same distance d the of the user from the device 102, the brightness (X or Y) of the display surface 102 can be different depending on the ambient brightness (e.g., dim lit vs. well lit).

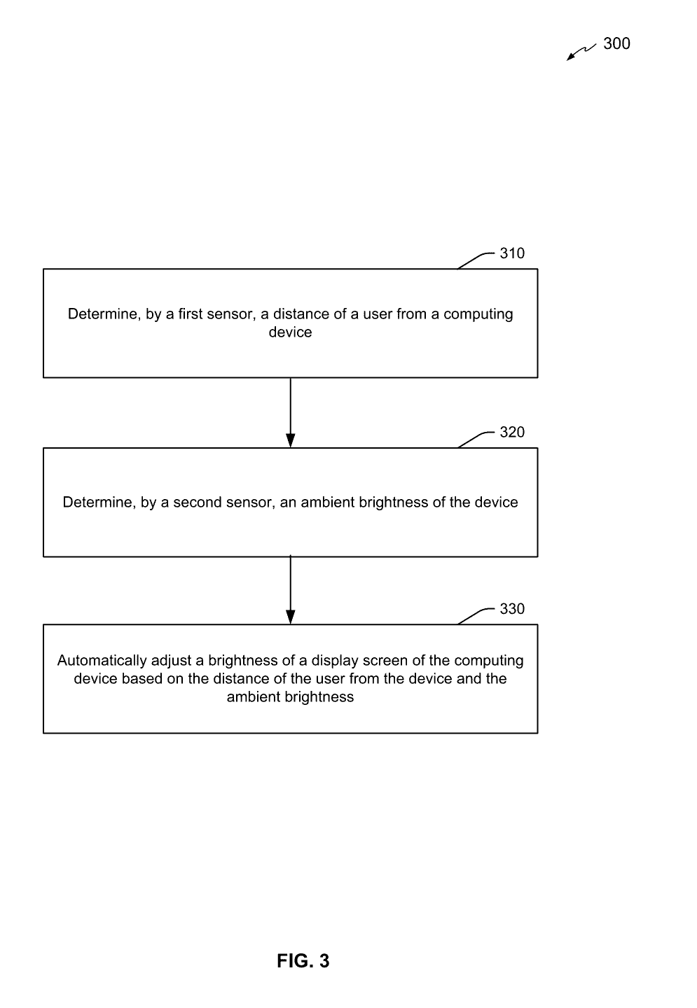

FIG. 3 is an example of a flowchart illustrating a method for adjusting a brightness of a display screen of a computing device based on a distance of a user from the device. Method 300 may be implemented, for example, in the form of executable instructions stored on a non-transitory computer-readable storage medium and/or in the form of electronic circuitry.

Method 300 includes determining, by a first sensor, a distance of a user from the device, at 310. For example, first sensor 108 can determine the distance of the user from the device 102. First sensor 108 can be one or more of an image sensor and a sound sensor.

Method 300 includes determining, by a second sensor, an ambient brightness of the device, at 320. For example, second sensor 110 can determine the ambient brightness (i.e., the brightness of the environment or surrounding of the device 102). Second sensor 110 can be a light sensing device such as a photosensor, a photodetector, or an ambient light sensor.

Method 300 includes automatically adjusting a brightness of the display screen of the device based on the distance of the user from the device and the ambient brightness. For example, controller 104 can automatically adjust the brightness of the display 106 based on the distance d of the user from the device 102 and the ambient brightness. In some examples, the method 300 of FIG. 3 includes additional steps in addition to and/or in lieu of those depicted in FIG. 3.

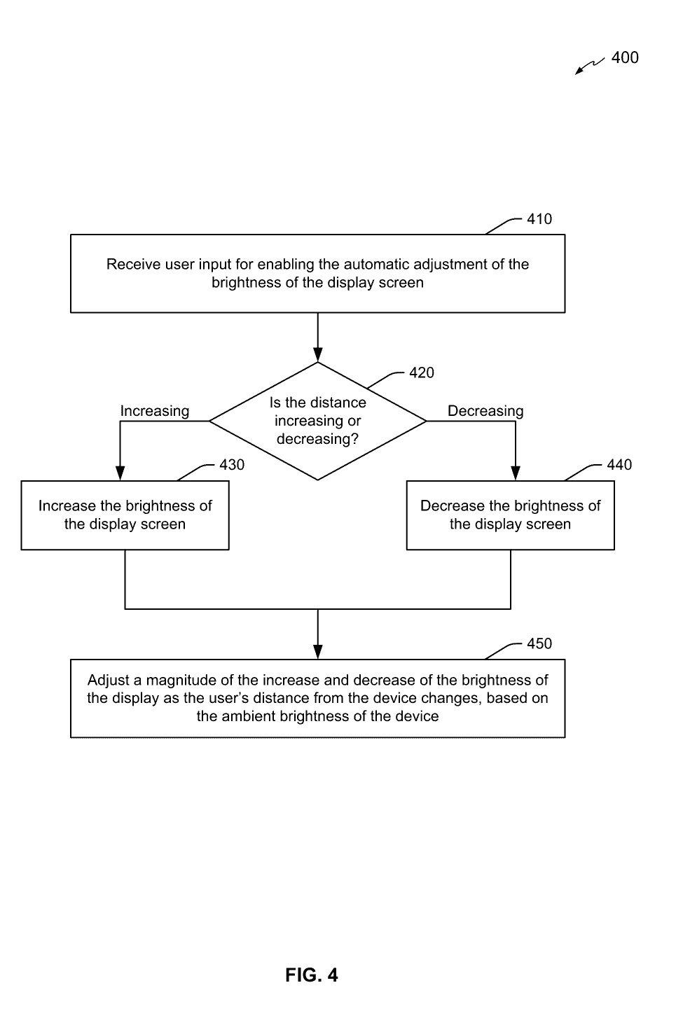

FIG. 4 is another example of a flowchart illustrating a method for adjusting a brightness of a display screen of a computing device based on a distance of a user from the device. Method 400 may be implemented, for example, in the form of executable instructions stored on a non-transitory computer-readable storage medium and/or in the form of electronic circuitry.

Method 400 includes receiving user input for enabling automatic adjustment of the brightness of the display screen, at 410. For example, the user may be provided with an option to select or deselect the automatic brightness adjustment feature of the display 106 of the device. Enabling this feature causes the sensor 108 to determine the distance of the user from the device 102 and the sensor 110 to determine the ambient brightness.

Method 400 includes determining whether the distance of the user to the device is increasing or decreasing, at 420. If it is determined that the distance of the user to the device is increasing, method 400 includes increasing the brightness of the display screen, at 430. However, if it is determined that the distance of the user to the device is decreasing, method 400 includes decreasing the brightness of the display screen, at 440. For example, first sensor 108 can determine the proximity of the user to the device 102 and provide the information to the controller 104 for adjusting the brightness of the display 106 accordingly.

Method 400 includes adjusting a magnitude of the increase and decrease of the brightness of the display as the user's distance from the device changes, based on the ambient brightness, at 450. For example, second sensor 110 provides ambient brightness data to the controller 104. Controller 104 can modify the rate of change of the brightness of the display 106 (as the user's distance changes) or the magnitude of the change, based on the ambient brightness. Accordingly, the change in brightness of the display 106 as the user's distance changes, is a function of the ambient brightness. in some examples, the method 400 of FIG. 4 includes additional steps in addition to and/or in lieu of those depicted in FIG. 4.

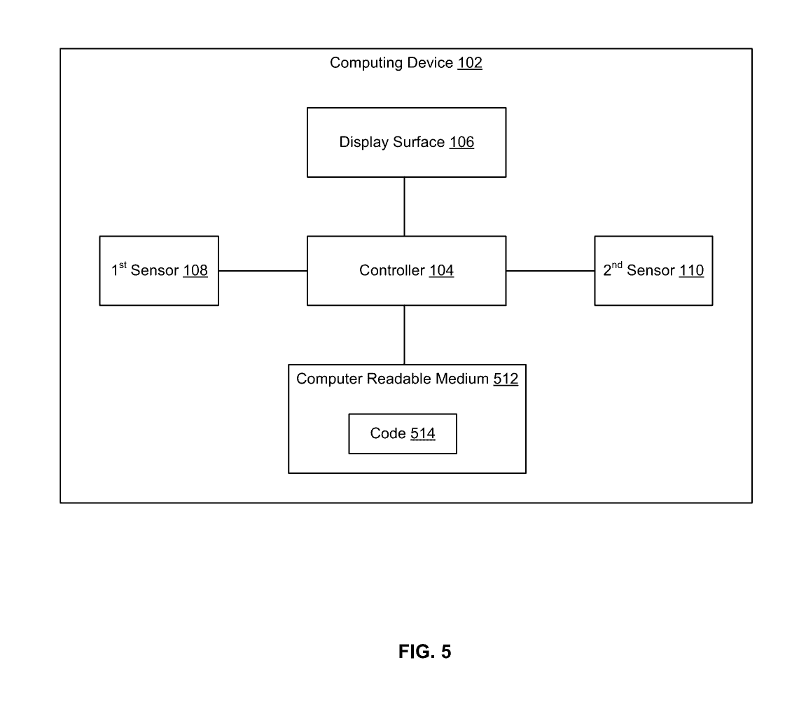

FIG. 5 illustrates an example of a computing device including a computer-readable medium having instructions to adjust a brightness of a display screen based on a distance of a user from the device. Computing device 102 includes computer-readable storage medium 512. Computer-readable storage medium 512 includes code 514 that, when executed by controller 104, causes controller 104 to determine a distance of a user from the device 102 and to determine an ambient brightness of the device 102. Data related to the distance can be provided by a first sensor 108 and data related to the ambient brightness can be provided by the second sensor 110. The code 514 can also cause the controller to automatically adjust the brightness of the display screen of the device based on the distance of the user from the device and the ambient brightness.

The techniques described above may be embodied in a computer-readable medium for configuring a computing system to execute the method. The computer-readable media may include, for example and without limitation, any number of the following non-transitive mediums: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and obvious types of computer-readable media may be used to store the software modules discussed herein. Computing systems may be found in many forms including but not limited to mainframes, minicomputers, servers, workstations, personal computers, notepads, personal digital assistants, tablets, smartphones, various wireless devices and embedded systems, just to name a few.

In the foregoing description, numerous details are set forth to provide an understanding of the present disclosure. However, it will be understood by those skilled in the art that the present disclosure may be practiced without these details. While the present disclosure has been disclosed with respect to a limited number of examples, those skilled in the art will appreciate numerous modifications and variations therefrom. It is intended that the appended claims cover such modifications and variations as fall within the true spirit and scope of the present disclosure.

What is claimed is:

1. A computing device comprising:
a display surface;
a first sensor to determine a distance of a user from the device;
a second sensor to determine an ambient brightness of the device; and
a controller to automatically adjust a brightness of the display surface based on the distance of the user from the device and the ambient brightness.

2. The computing device of claim 1, wherein the first sensor includes at least one of an image sensor and a sound sensor.

3. The computing device of claim 2, wherein the image sensor is to determine the distance of the user from the device based on detected image of the user, and wherein the sound sensor is to determine the distance of the user based on detected sound intensity of the user.

4. The computing device of claim 1, wherein the second sensor is to determine a brightness level of an environment of the device.

5. The computing device of claim 1, wherein the controller is to:
increase the brightness of the display surface as the user's distance from the device increases; and
decrease the brightness of the display surface as the user's distance from the device decreases.

6. The computing device of claim 5, wherein the controller is to adjust a rate of crease and decrease of the brightness of the display surface relative to the user's distance from the device based on the ambient brightness.

7. The computing device of claim 1, wherein the controller is to receive a user input for enabling the automatic adjustment of the brightness of the display surface based on the distance of the user from the device and the ambient temperature.

8. The computing device of claim 1, wherein the controller is to receive user input to increase and decrease the brightness of the display surface by at least one of a specific percentage, factor, and rate.

9. The computing device of claim 1, wherein the controller is to:
dim the display surface when the first sensor does not detect the user after a first predetermined period of time; and
turn off the display surface when the sensor does not detect the user after a second predetermined period of time.

10. A method for adjusting a brightness of a display screen of a computing device, comprising:
determining, by a first sensor, a distance of a user from the device;
determining, by a second sensor, an ambient brightness of the device; and
automatically adjusting the brightness of the display screen based on the distance of the user from the device and the ambient brightness.

11. The method of claim 10, comprising:
increasing the brightness of the display screen when the user's distance from the device increases; and
decreasing the brightness of the display screen when the user's distance from the device decreases.

12. The method of claim 11, comprising adjusting a magnitude of the increase and decrease of the brightness of the display screen as the user's distance from the device changes, based on the ambient brightness of the device.

13. The method of claim 10, comprising receiving user input for enabling the automatic adjustment of the brightness of the display screen, prior to automatically adjusting the brightness of the display screen.

14. A non-transitory computer-readable medium comprising instructions that, when executed by a controller in a computing device, cause the controller to:
determine a distance of a user from the device;
determine an ambient brightness of the device; and
automatically adjust the brightness of a display screen of the device based on the distance of the user from the device and the ambient brightness of the device.

15. The non-transitory computer-readable medium of claim 14, wherein the instructions are further executable by the controller to:
increase the brightness of the display screen as the user's distance from the device increases; and
decrease the brightness of the display screen as the user's distance from the device decreases,
wherein a magnitude of the increase and decrease of the brightness of the display screen is based on the ambient brightness of the device.
